(19) United States
(12) Patent Application Publication
(10) Pub. No.: US 2011/0095737 A1
(43) Pub. Date: Apr. 28, 2011

(54) VOLTAGE REGULATOR, AND INTEGRATED CIRCUIT USING THE SAME

(75) Inventors: Yuan-Kai Chu, Tainan County (TW); Hui-Min Wang, Tainan County (TW)

(73) Assignees: HIMAX TECHNOLOGIES LIMITED, Tainan County (TW); HIMAX MEDIA SOLUTIONS, INC., Tainan County (TW)

(21) Appl. No.: 12/606,468

(22) Filed: Oct. 27, 2009

(51) Int. Cl. G05F 1/10

(52) U.S. Cl. 323/281

(57) ABSTRACT

A voltage regulator and an integrated circuit using the voltage regulator is provided. The voltage regulator has a bandgap reference circuit, an operational amplifier, a power transistor and a voltage divider. The bandgap reference circuit generates a bandgap reference voltage. The operational amplifier receives the bandgap reference voltage and a feedback voltage to output a control signal for the power transistor. The power transistor is powered by a first voltage source and transforms the first voltage source to a second voltage source according to the control signal. The second voltage source is divided by the voltage divider to generate the feedback voltage and is further used in powering the bandgap reference circuit and the operational amplifier.

### BACKGROUND OF THE INVENTION

1. Field of the Invention

The present invention relates to voltage regulators, and in particular relates to voltage regulators providing voltage transformation.

2. Description of the Related Art

According to thickness of a gate oxide, semiconductor devises may be divided into high voltage (HV) devices and low voltage (LV) devices. HV devices have transistors with a thick gate oxide, and LV devices have transistors with a thin gate oxide. Because the operable voltage levels of the devices are dependent on the thickness of the gate oxide of the devices, the HV devices can be powered by high voltage sources (for example, 3.3V˜5V, hereinafter VDDH) while the LV devices are limited to low voltage sources (for example 1.8V, hereinafter VDDL). Using a high voltage source VDDH with a LV device, may damage the LV device.

Generally, the available voltage source for a computing system may be up to 5 volts (VDDH). To power LV devices in an IC, a voltage regulator transforming the high voltage source VDDH to a low voltage source VDDL is called for.

### BRIEF SUMMARY OF THE INVENTION

The invention discloses a voltage regulator transforming a high voltage power to a low voltage power.

An exemplary embodiment of the voltage regulator comprises a bandgap reference circuit, an operational amplifier, a power transistor and a voltage divider. The bandgap reference circuit generates a bandgap reference voltage. The operational amplifier receives the bandgap reference voltage and a feedback voltage to output a control signal for the power transistor. The power transistor is powered by a high voltage source, and transforms the first voltage source to a second voltage source according to the control signal. The voltage divider divides the second voltage source to generate the feedback voltage. Furthermore, the second voltage source is coupled to the bandgap reference circuit and the operational amplifier for power thereto.

The invention further discloses an integrated circuit (IC) using the voltage regulator. The IC comprises a first pin, a second pin, a bandgap reference circuit, an operational amplifier and a voltage divider. The first pin is operative to be coupled to a power transistor outside of the IC. The power transistor, powered by a first voltage source, transforms the first voltage source to a second voltage source according to a control signal provided at the first pin of the IC. The generated second voltage source is inputted to the IC by the second pin. The voltage divider in the IC divides the received second voltage source to generate a feedback voltage. The operational amplifier in the IC receives a bandgap reference voltage (generated by the bandgap reference circuit in the IC) and the feedback voltage to generate the control signal at the first pin. In the IC, the bandgap reference circuit and the operational amplifier are both powered by the second voltage source received at the second pin.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts a voltage regulator according to an exemplary embodiment of the invention;

FIG. 2 depicts another voltage regulator according to an exemplary embodiment of the invention; and

FIG. 3 depicts an exemplary embodiment of a voltage divider.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

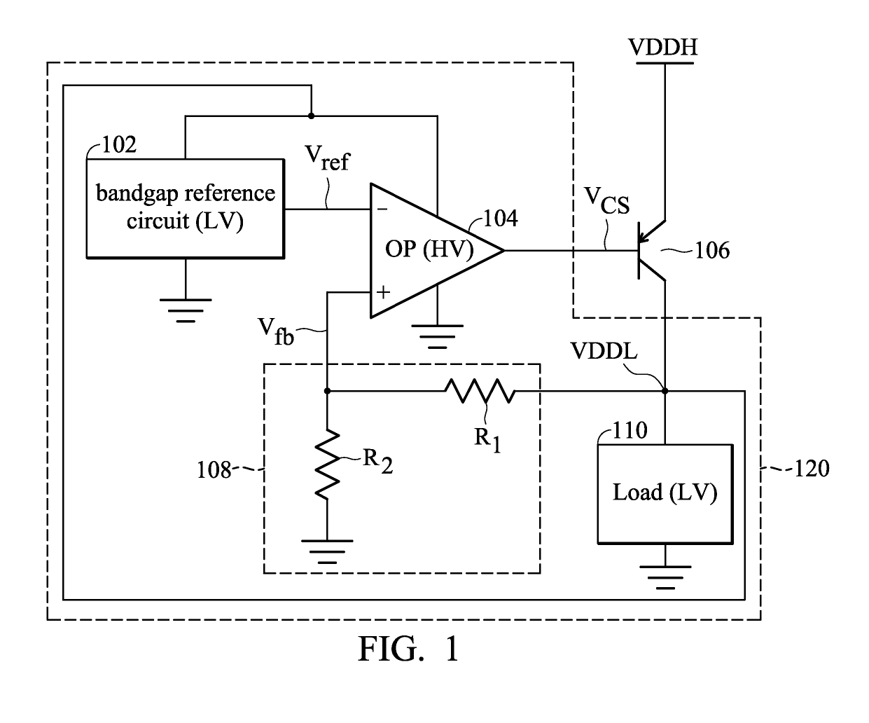

FIG. 1 depicts a voltage regulator according to an exemplary embodiment of the invention. The voltage regulator comprises a bandgap reference circuit 102, an operational amplifier 104, a power transistor 106 and a voltage divider 108. The voltage regulator transforms a high voltage source VDDH to a low voltage source VDDL to power LV devices (for example, the load 110, having transistors with a thin gate oxide). To operate with a high load current, the power transistor 106 may be a HV device with a thick gate oxide. The power transistor 106 is powered by the high voltage source VDDH, and transforms the first voltage source VDDH to the low voltage source VDDL according to a control signal V_{CS}. To maintain the low voltage source VDDL within a stable region, the bandgap reference circuit 102, the operational amplifier 104 and the voltage divider 108 are provided. The voltage divider 108 (may comprises resistors R₁ and R₂) divides the low voltage source VDDL to generate a feedback voltage V_{fb}. The operational amplifier 104 compares the feedback voltage V_{fb} with a bandgap reference voltage V_{ref} (generated by the bandgap reference circuit 102) to generate the control signal V_{CS} to control the power transistor 106. Note that the generated low voltage source VDDL is not only used to power the LV load 110, but is further coupled to the bandgap reference circuit 102 and the operational amplifier 104 for power thereto. Referring to the circuit shown in FIG. 1, only the power transistor 106 is powered by the high voltage source VDDH, while the rest of the components (including the bandgap reference circuit 102 and the operational amplifier 104) are powered by the generated low voltage source VDDL.

In the embodiment shown in FIG. 1, the bandgap reference circuit 102 may be a HV device having transistors with a thick gate oxide or a LV device having transistors with a thin gate oxide, and the operational amplifier 104 is limited to be an HV device. For the bandgap reference circuit 102, the requirement for gate oxide thickness is not very strict, because the bandgap reference circuit 102 is powered by a low voltage source VDDL and the voltage levels of the signals therein are limited within an acceptable region. The bandgap reference circuit 102 of a HV technique or a LV technique can both perform normally while the power supply thereof is the low voltage source VDDL. However, compared to the bandgap reference circuit, the gate oxide thickness in the operational amplifier 104 is designed strictly because the voltage level of the control signal V_{CS} is dependent on the value of the high voltage source VDDH and the threshold voltage of the power transistor 106 and may be much higher than the acceptable voltage region of LV devices. Thus, the operational amplifier 104 should be a HV device having transistors with a thick gate oxide rather than a LV device having transistors with a thin gate oxide.

The voltage regulating technique may be applied to power LV devices of an IC. Referring to FIG. 1, the dashed block 120 shows an IC, having a first pin transmitting the control signal V_{CS} to the HV power transistor 106 and has a second pin receiving the low voltage source VDDL generated by the power transistor 106. The bandgap reference circuit 102, the operational amplifier 104 and the voltage divider 108 are manufactured in the IC 120. An outstanding advantage of this design is that the required pins of the IC 120 is decreased because the IC 120 does not have to receive the high voltage source VDDH.

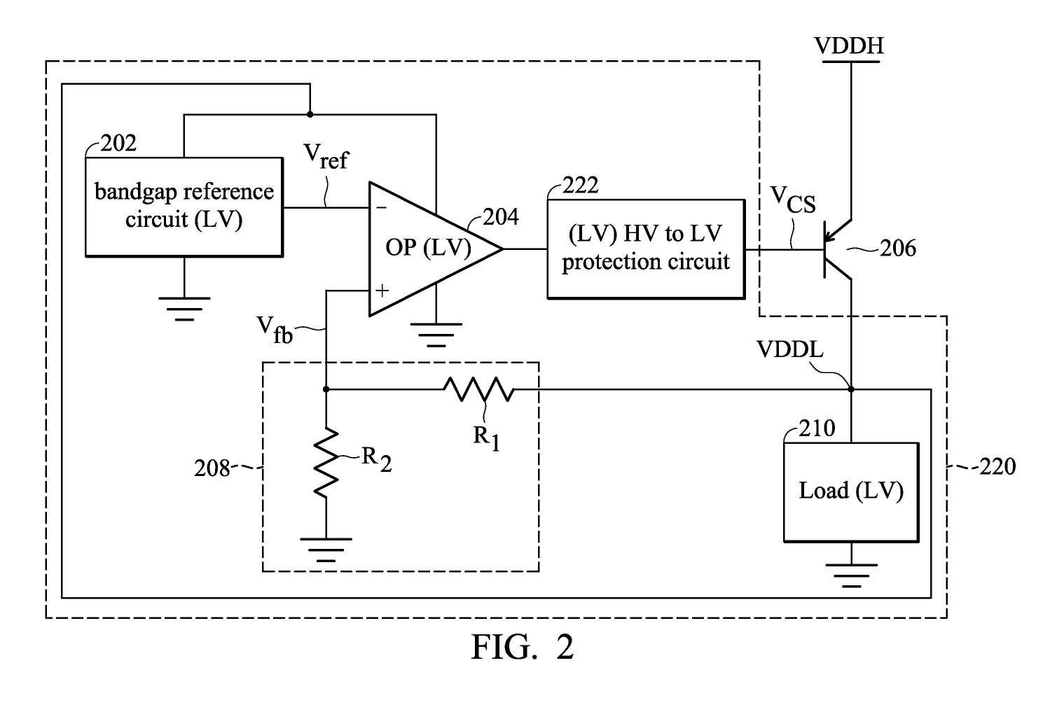

FIG. 2 shows another exemplary embodiment of the invention. Compared with the circuit of FIG. 1, FIG. 2 further comprises an HV to LV protection circuit 222 and the bandgap reference circuit 202 and the operational amplifier 204 therein are LV devices. The HV to LV protection circuit 222 provides a voltage drop between the control terminal of the power transistor 206 and the output of the operational amplifier 204. When the voltage value of the control signal V_{CS}, dependent on the high voltage source VDDH and the threshold voltage of the power transistor 206, is much higher than the maximum voltage that thin gate oxide transistors can operate with, the HV to LV protection circuit 222 provides a voltage drop to shift the control signal V_{CS} to a lower voltage level.

The bandgap reference circuit 202, the operational amplifier 204, the voltage divider 208 and the HV to LV protection circuit 222 may be designed in an IC 220 to drive the LV load 210 of the IC 220. Also, the IC 220 does not require a pin for receiving the high voltage source VDDH. Furthermore, the manufacturing of the IC 220 is much simpler than that of IC 120 of FIG. 1 because the circuits therein are all LV design (thin gate oxide) and fewer masks are required.

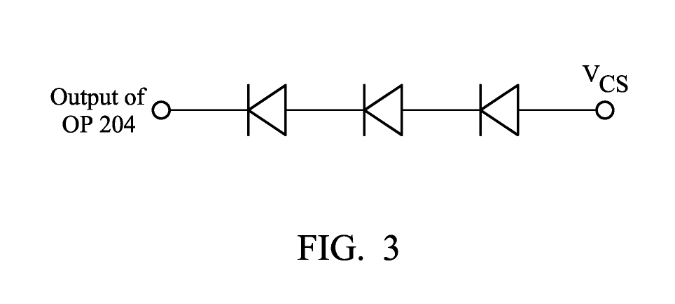

FIG. 3 shows an example of the HV to LV protection circuit 222. As shown, the HV to LV protection circuit may comprise one or more diodes. The diodes provide a voltage drop between the control signal V_{CS} and the output of the operational amplifier 204. Note that the circuit shown in FIG. 3 does not limit the structure of the HV to LV protection circuit 222. The HV to LV circuit may be realized by other techniques.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A voltage regulator, comprising
a bandgap reference circuit, generating a bandgap reference voltage;
a operational amplifier, receiving the bandgap reference voltage and a feedback voltage to output a control signal for a power transistor;
the power transistor, powered by a first voltage source and transforming the first voltage source to a second voltage source according to the control signal; and
a voltage divider, dividing the voltage level of the second voltage source to generate the feedback voltage,
wherein the bandgap reference circuit and the operational amplifier both are powered by the second voltage source.

2. The voltage regulator as claimed in claim 1, wherein voltage level of the first voltage source is higher than that of the second voltage source.

3. The voltage regulator as claimed in claim 2, further providing a load with the second voltage source, wherein the load comprises transistors with a thin gate oxide, and the power transistor has a thick gate oxide.

4. The voltage regulator as claimed in claim 3, wherein the operational amplifier has transistors with a thick gate oxide.

5. The voltage regulator as claimed in claim 3, wherein the operational amplifier has transistors with a thin gate oxide.

6. The voltage regulator as claimed in claim 5, further comprising a high voltage to low voltage protection circuit coupled between the operation amplifier and the power transistor.

7. The voltage regulator as claimed in claim 6, wherein the high voltage to low voltage protection circuit comprises a diode which has an anode coupled to the power transistor and has a cathode coupled to the operational amplifier.

8. The voltage regulator as claimed in claim 6, wherein the bandgap reference circuit has transistors with a thin gate oxide.

9. An intergraded circuit, comprising:
a first pin;
a second pin;
a bandgap reference circuit, generating a bandgap reference voltage;
a operational amplifier, receiving the bandgap reference voltage and a feedback voltage to output a control signal at the first pin, wherein the first pin is coupled to a power transistor outside of the integrated circuit, the power transistor is powered by a first voltage source and transforms the first voltage source to a second voltage source according to the control signal, and the second voltage source is coupled to the integrated circuit via the second pin; and
a voltage divider, coupled to the second pin for the second voltage source, and dividing the voltage value of the second voltage source to generate the feedback voltage,
wherein the bandgap reference circuit and the operational amplifier both are powered by the second voltage source received by the second pin.

10. The integrated circuit as claimed in claim 9, wherein the voltage of the second voltage source is lower than that of the first voltage source.

11. The integrated circuit as claimed in claim 10, further comprising a load coupled to the second pin to be powered by the second voltage source, wherein the load comprises transistors with a thin gate oxide and the power transistor has a thick gate oxide.

12. The integrated circuit as claimed in claim 11, wherein the operational amplifier has transistors with a thick gate oxide.

13. The integrated circuit as claimed in claim 11, wherein the operational amplifier has transistors with a thin gate oxide.

14. The integrated circuit as claimed in claim 13, further comprising a high voltage to low voltage protection circuit coupled between the operation amplifier and the first pin.

15. The integrated circuit as claimed in claim 14, wherein the high voltage to low voltage protection circuit comprises a diode which has an anode coupled to the first pin and has a cathode coupled to the operational amplifier.

16. The integrated circuit as claimed in claim 14, wherein the bandgap reference circuit has transistors with a thin gate oxide.
